(19) United States
(12) Patent Application Publication
(10) Pub. No.: US 2006/0258419 A1
(43) Pub. Date: Nov. 16, 2006

(54) Creating publications using gaming-based media content

(75) Inventors: Marvin Winkler, Laguna Hills, CA (US); Ralph E. Seibert, Laguna Niguel, CA (US)

Correspondence Address: CROWELL & MORING LLP;INTELLECTUAL PROPERTY GROUP, P.O. BOX 14300, WASHINGTON, DC, 20044-4300, US

(73) Assignee: PLANETWIDE GAMES, INC., Aliso Viejo, CA (US)

(21) Appl. No.: 11/433,222

(22) Filed: May 11, 2006

Related U.S. Application Data
(60) Provisional application No. 60/679,706, filed on May 11, 2005.

(51) Int. Cl. A63F 13/00

(52) U.S. Cl. 463/1

(57) ABSTRACT

The creation of a personal publication is provided by enabling a user to capture gaming-based media content which is used to populate a page, along with other media and text to create a story or narrative of the actual in-game events. One or more page templates organized into sequential panels may be used to aid in the creation of the story or narrative. A publication, such as a comic book, may then be printed where the publication is comprised of pages based on the aforementioned page template(s) filled with the previously-captured in-game media content, and then augmented with other images, text or graphics.

### CROSS-REFERENCE TO RELATED APPLICATION

This application is related to and claims priority from the United States provisional patent application having application No. 60/679,706, filed on May 11, 2005.

### 1. FIELD OF THE INVENTION

This invention relates generally to accessing gaming-based media content, and in particular to using gaming-based media content to create publications.

### 2. BACKGROUND

Role playing games (RPGs) are games where players assume the roles of fictional characters via role-playing. At their core, these games are a form of interactive and collaborative storytelling. Whereas cinema, novels and television shows are passive, role-playing games engage the participants actively, allowing them to simultaneously be audience, actor and author.

Each player's character has a number of characteristics, often including strength, intelligence, charisma, and various paranormal traits. The exact abilities vary by game. Numerical values assigned to these characteristics reflect the character's learned and intrinsic attributes and abilities, and can be used during game play to evaluate the outcome of various chance events. In most game systems, most or all of these characteristics can be improved in some way via gameplay, usually by gaining experience points for completing certain objectives.

Having evolved from a pen-and-paper game played with dice, today most RPGs are played via the computer. Computer RPGs often involve intricate plots and character development as characters advance through a large number of statistics, items and abilities. Players must usually choose which of several possible combinations of these things to acquire for their character in order to advance, and if possible, win the game.

A more recent form of RPGs are massive(ly) multiplayer online role-playing games (MMORPGs). MMORPGs are multiplayer computer RPGs that enable potentially thousands of players to play in an evolving virtual world at the same time in an online environment. Players run a client to connect to an MMORPG and a game master (which is usually the game's publisher, manager, or director), manages and/or hosts the game world. Most MMORPGs are commercial and require the player to pay a monthly fee in order to play. The virtual worlds they create are called “persistent worlds”, meaning that the world continues regardless of who is logged in or not. When a player logs in, they are represented in the game world by an avatar—a graphical representation of the character they play. Once a player enters the world, they can engage in a variety of activities with other players who are accessing the game the same way from all over the world. MMORPG developers are in charge of supervising the virtual world and offering the users a constantly updated set of new activities and enhancements to guarantee the interest of players. Most MMORPGs are commercial in that a user must pay money for the client software and/or a subscription-based fee, in order to continually access the virtual world.

Players of RPG and MMORPG games may accumulate an archive of pictures and images taken during their challenges, battles, and exploits inside of a virtual world. While these images may be shared between players but not in manner carry the context in which they were created. Thus, there is a need to be able to assemble a publication based on media content derived from gaming activities that can be shared with others and which preserves the narrative context.

### BRIEF SUMMARY OF THE INVENTION

The invention relates to creating publications using gaming-based media content. In one embodiment, a method for creating a publication includes capturing media content based on a gaming activity, populating a plurality of panels of a page template with the captured media content, and generating a first digital page using the page template and the media content. The method further includes compiling a plurality digital pages, which includes the first digital page, into a publication.

Other aspects, features, and techniques of the invention will be apparent to one skilled in the relevant art in view of the following detailed description of the invention.

### BRIEF DESCRIPTION OF THE DRAWINGS

FIG. 1 depicts one embodiment of a process for how captured image content may be used to populate a publication in accordance with the invention;

FIG. 2 depicts one embodiment of a process for printing the publication of FIG. 1;

FIG. 3 illustrates one embodiment of a page template with different panels;

FIG. 4 describes one embodiment of a page template and how content may be customized for the particular panels of the template;

FIGS. 5A-5C illustrates embodiments of different page template layouts in accordance with the principles of the invention;

FIG. 6 illustrates how a frame can be selected from a video clip and used to populate one or more panels of a page template, according to one embodiment;

FIGS. 7A-7B depict embodiment of how a video file may be used to populate one or more panels of one or more templates across one or more pages of a publication;

FIGS. 8A-8B depict embodiments of graphical user interfaces for implementing one or more aspects of the invention; and

FIG. 9 is a process for capturing and utilizing gaming-based media content, in accordance with one embodiment of the invention.

### DETAILED DESCRIPTION OF THE EXEMPLARY EMBODIMENTS

One aspect of the invention is to assemble media content collected during gaming (RPG/MMORPG) into a narrative context. In one embodiment, online or offline gamers may capture images of their in-game experiences (e.g., using a software utility or game feature) and compile them into a sequence. While in one embodiment such images may be individually selected, in another embodiment a sequential collection of images may be captured.

Once the desired content (e.g., series of images) has been collected, a graphical user interface (GUI) of a software application may be used to populate one or more page templates comprised of a series of panels. A user may then create a narrative by placing the images in order on the template and then adding text, text balloons, or other graphical and text-based augmentations to describe the story that the selected images demonstrate. In one embodiment, the GUI may be used to drag and drop an image into a panel and to position (moved horizontally or vertically) or scale (made larger or smaller) the particular image within that panel. If the image is larger than the panel then the content outside of the panel height and width may be cropped, or alternatively the image resized. If, on the other hand, the image is smaller than the panel then the content may be displayed on a customized background.

While in one embodiment the page template and panels may have the appearance of comic book pages, it should be appreciated that the finished product may be any publication format. For example, the publication may be published in any digital file type (e.g., PDF, BIT map, JPEG, HTML), as well as published to the World Wide Web. In certain embodiment, it may be desirable to secure the published content using various digital security technology. Publications in accordance with the invention may also be encoded onto a digital storage medium, such as DVD (digital versatile disc or digital video disc) and Blu-ray ROM media.

Once complete, the finished publication may then be stored, emailed, transferred, or printed in accordance with user-provided preferences. In another embodiment, the distribution and/or copying of the publication may be restricted by digital rights and/or licenses.

Another aspect of the invention is to capture one or more video clips of online or offline game play using, for example, a utility or game feature. In this embodiment, a user may then use a GUI of a software application to drag and drop the individual frames of a video clip onto a template. In one embodiment, the template may be comprised of a series of individual video frames which arrange themselves into an order based on the order of the frames in the movie and the order of panels in the template. The user may then select to have only every nth frame (e.g., 3^{rd}, 5^{th}, etc.) dropped into the template from the movie. In another embodiment, the frame that is dropped into the panel of the template may be shifted by going forward or backward one frame at a time in the video clip. Thereafter, text, text balloons, or other augmentations may be added to the image(s) to describe and provide context for the story that the selected images relate to. The finished product may then be stored, emailed, transferred, or printed in accordance with user preferences.

In order to help preserve the context of the captured gaming-based media content, each page may also have other graphic and/or text content that is “global” to the page or to a grouping of pages. Global material can be positioned anywhere on the page irrespective of panels and images. Global material may include, for example, lines, boxes, shapes, text, “talking balloons,” images, caption boxes or other bitmap and vector graphic material. In one embodiment, global material may be dragged and dropped and then scaled and positioned anywhere on a given page.

In accordance with the practices of persons skilled in the art of computer programming, the invention is described below with reference to symbolic representations of operations that are performed by a computer system or a like electronic system. These various operations may be carried out using one or more GUIs of a software application executing on a user's computer. Such operations are sometimes referred to as being computer-executed. It will be appreciated that operations that are symbolically represented include the manipulation by a processor, such as a central processing unit, of electrical signals representing data bits and the maintenance of data bits at memory locations such as in system memory, as well as other processing of signals. The memory locations where data bits are maintained are physical locations that have particular electrical, magnetic, optical, or organic properties corresponding to the data bits. Thus, the term “computer” is understood to include any electronic device that contains a processor, such as a central processing unit.

When implemented in software, the elements of the invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

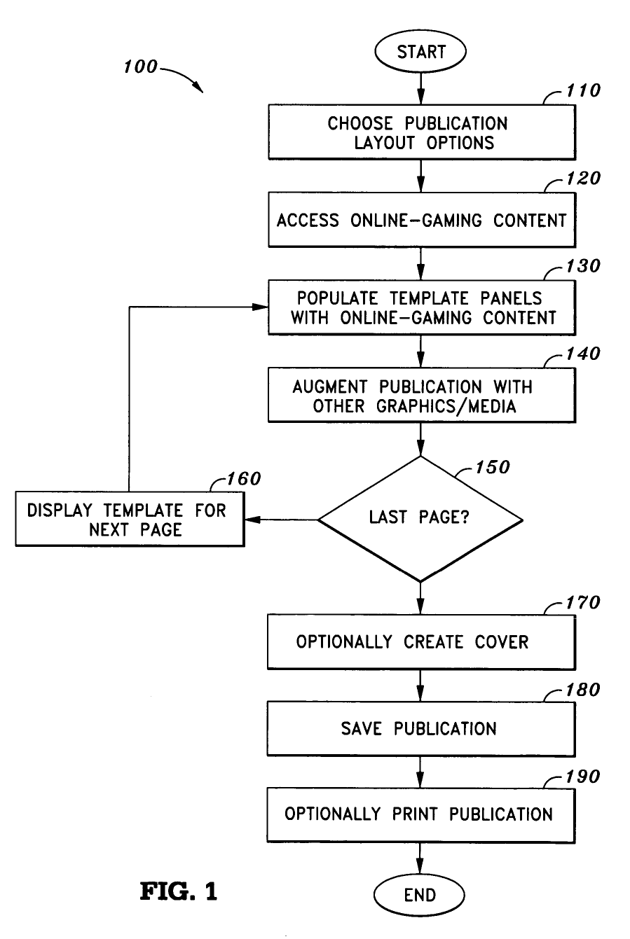

Referring now to FIG. 1, depicted is one embodiment of a process 100 for carrying out one or more aspects of the invention using, for example, a software application executing on a user's computer system. It should be appreciated that prior to the beginning of process 100, the online-gaming content to be used to create a publication has already been captured. As previously mentioned, such gaming-based media content may be captured while in-game using native capture functionality or third-party utilities that copy the screen memory contents to one or more formatted files. Such content may include one or more images, whether sequentially captured or not, as well as one or more video clips of actual in-game activities. The gaming activity from which such media content is derived may be engaged in online in a RPG/MMORPG environment. Alternatively, the media content may be derived from offline gaming activities, such single player gaming or offline multi-player gaming.

Process 100 begins at block 110 where the user may choose from among a plurality of template layouts, background colors, styles, and numerous other publications parameters using a GUI generated by a computer-executed software application. In one embodiment, each template is comprised of one or more panels of particular sizes and having a particular arrangement. Once the publication layout options have been chosen, the user may then browse to or otherwise locate the previously-captured gaming-based content to be used in the publication (block 120). While in one embodiment, the content may be located in a local directory, it may similarly be located at a remote network location.

Once the gaming-based content to be used has been accessed and/or located, process 100 continues to block 130 where the template panels may be populated for what is going to be the first page of the publication. In one embodiment, panels may be populated by dragging and dropping an image or video clip from a resource window of the GUI onto a particular panel. As previously mentioned, each image or video clip that is dropped into a panel can be positioned or scaled within that panel.

Once all of the panels of the current page have been populated with content, the user may then add global page augmentations by dragged and dropped them onto the page at desired locations (block 140). In one embodiment, such global page augmentations may include, for example, lines, boxes, shapes, text, “talking balloons,” images, or other bitmap and vector graphic material that may provide further context to the images being used. It should similarly be appreciated that such augmentations may be made prior to the completion of panel population.

In another embodiment, the user may drop an image sequence or video clip onto a page to auto-populate the panels in the template(s) over several pages. This would allow a user to quickly create a multiple page publication (e.g., comic book).

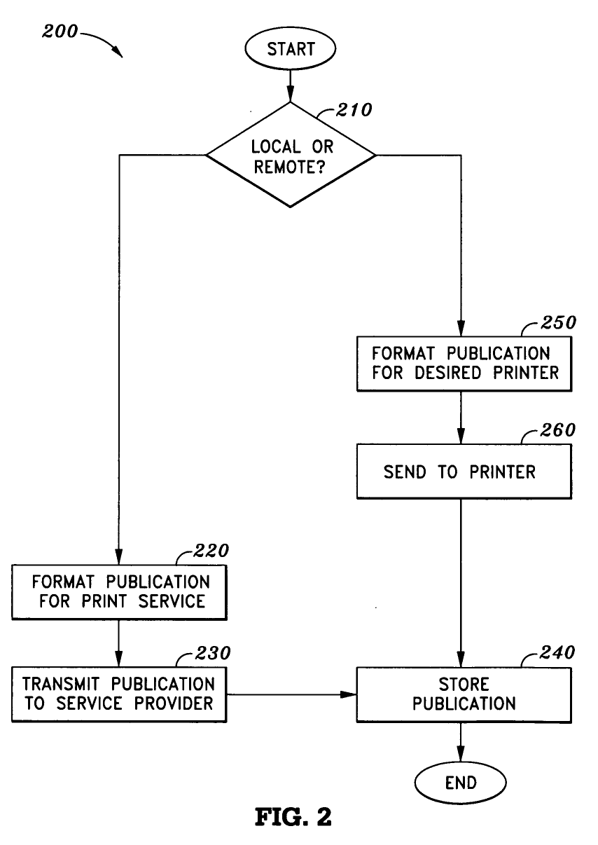

At decision block 150, a determination may then be made as to whether the publication is to have any additional pages, or whether the current page is to be the last page. If it is not the last page, then process 100 will continues to block 160 where a template for the next page is displayed to the user. While in one embodiment the template layout for the previous page is used, in another embodiment the user may be given the option to select a different template layout, background color, etc. If, on the other hand, it is determined at block 150 that the current page is to be the last page, then process 100 will move to block 170 where a publication cover may optionally be created. In one embodiment, the user may select artwork or other imagery comprised of images, shapes, drawings, and/or text to serve as the publication's cover. Thereafter, the publication may be saved locally or remotely, along with user information and any digital rights or other rights-related information at block 180. Thereafter, the publication may be optionally printed at block 190, as discussed in more detail below with reference to FIG. 2.

FIG. 2 describes the print process 200 referred to above at block 190 of FIG. 1. In particular, process 200 begins with a determination at block 210 as to whether or not the publication is to be printed on a local printer or remotely by a print service provider. In one embodiment, the print service provider may print, bind, and offer other publication-related services for the user. If, on the one hand, the user decides to send it to a print service provider, the publication may be scaled and formatted at block 220. The individual service provider's features may determine the scale and format of the publication file that is to be sent. To that end, the publication pages, panels, text, and graphics may all be scaled to meet the resolution and size requirements of the provider in question. The user may also select additional binding options, shipping options, or provide other information as may be required by the service provider. Then, at block 230, the file(s) containing the publication may be uploaded over a network connection to the print service provider's server or exported into a new print format that is then stored at block 240.

If, on the other hand, a determination is made at block 210 that the publication is to be printed locally, then process 200 will continue to block 250 where the publication pages, panels, text, and graphics are all scaled to meet the resolution and size requirements of the local printer. Then, at block 260, the publication may be sent to the local printer for printing. As with remote printing, the publication, as finally formatted, is then stored at block 240.

It should further be appreciated that the publication may similarly be published in any digital file type (e.g., PDF, BIT map, JPEG, HTML), as well as published to the World Wide Web. In certain embodiment, it may be desirable to secure the published content using various digital security technology. Publications in accordance with the invention may also be encoded onto a digital storage medium, such as DVD (digital versatile disc or digital video disc) and Blu-ray ROM media.

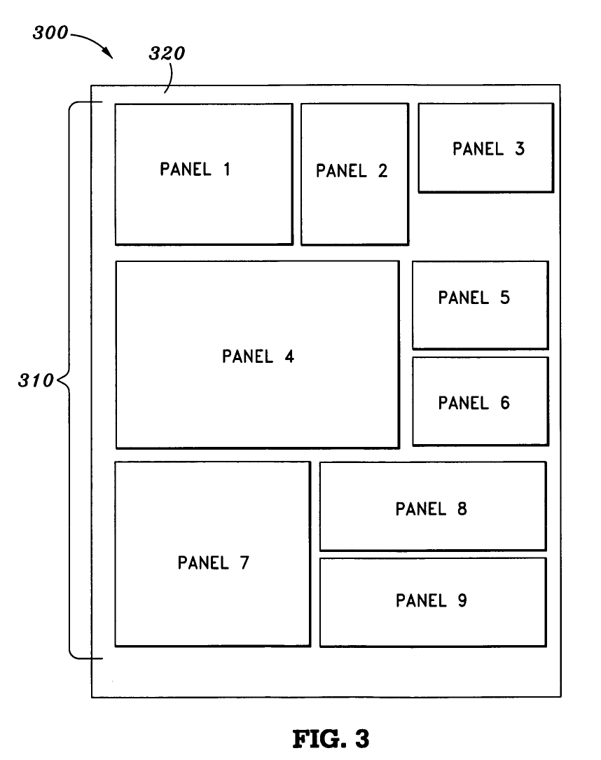

Referring now to FIG. 3, depicted is one embodiment of a page template 300 comprised of a panel sequence 310 set against a background 320. As previously mentioned, background 320 can be user set to any color, gradient of colors, pattern hash, or image. In certain embodiments, panel sequence 300 may be displayed to a user via a GUI generated by a computer-executed application. Along with the panel sequence 300, the GUI may also contain other sections or windows populated with one or more icons for providing additional user functionality (e.g., tool bars, resource windows, option menus, etc.).

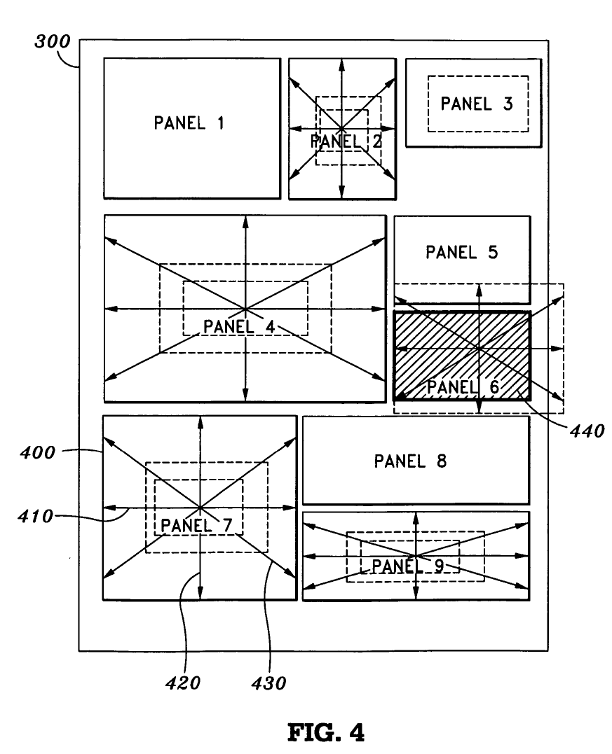

FIG. 4 is another embodiment of page template 300 depicting how media content may be scaled and/or positioned with the panels. As previously mentioned, one aspect of the invention is to enable any image or video clip that is dropped into a panel to be positioned, scaled and/or cropped. For example, with reference to panel 400, lines 410 and 420 indicate how the image/clip can be moved around the panel and specifically positioned. In one embodiment, a user may select use a mouse or other type of input to select and drag the image/clip in the directions indicated by lines 410 and 420. Similarly, using a select-and-drag operation line 430 indicates how the image/clip may be scaled up to fill up panel 400, or reduced to fit within the panel 400. In another embodiment, the larger image or clip 440 may be cropped to fit a smaller panel (e.g., Panel 6).

Continuing to refer to FIG. 4, in another embodiment a user may delete an image (e.g., in panel 7) causing a cascade of moving the content from panel 8 into panel 7, content from panel 9 moving into panel 8, and the next page panel 1 moving into panel 9. It should equally be appreciated that this cascading of content may occur in reverse with an insert.

The unique problem in doing this is the attached text boxes and balloons that have to move with the images. They are anchored (spatially) to each image and they have to move with the image into a panel that may have a different aspect ratio (and scale) and not cause a mess to happen. To that end, another aspect of the invention is to intelligently re-format images and/or associated text when such cascading movement occurs.

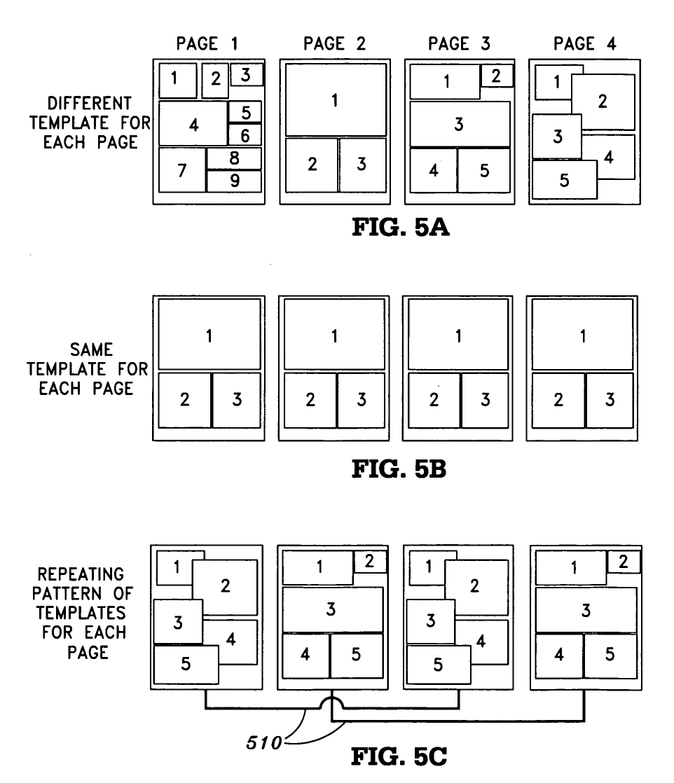

Referring now to FIGS. 5A-5C, depicted are embodiments of how various templates may be applied to create a personal publication, such as a comic book. In particular, FIG. 5A depicts how a different template may be used for each page (i.e., pages 1-4) in the publication. In contrast, FIG. 5B illustrates how the same template may be used for each page (i.e., pages 1-4) of the publication. And finally, FIG. 5C demonstrates a repeating pattern 510 of two templates which alternate in succession. While in this embodiment, the repeating pattern 510 involves two templates, it should equally be appreciated that the pattern may be comprised of 2, 3, 4 or more templates.

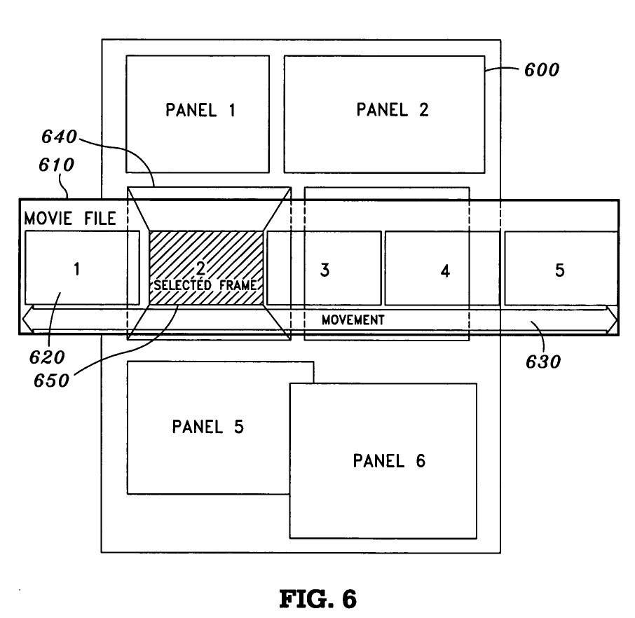

FIG. 6 illustrates how individual frames from a video clip can be used to populate a panel. In particular, video content created while in-game can be used to populate a panel (e.g., panel 600) of a template using a movie/video file 610 comprised of a series of sequential images. In this embodiment, the movie file 610 begins with a first image 620 and progresses through a series of sequential images which can be navigated, as shown by movement bar 630. In one embodiment, a user may change the currently-selected frame by going forward or backward in the image sequence by selecting, for example, movement bar 630. In the embodiment of FIG. 6, the currently-selected panel is panel 640 and the currently-selected frame is frame 650.

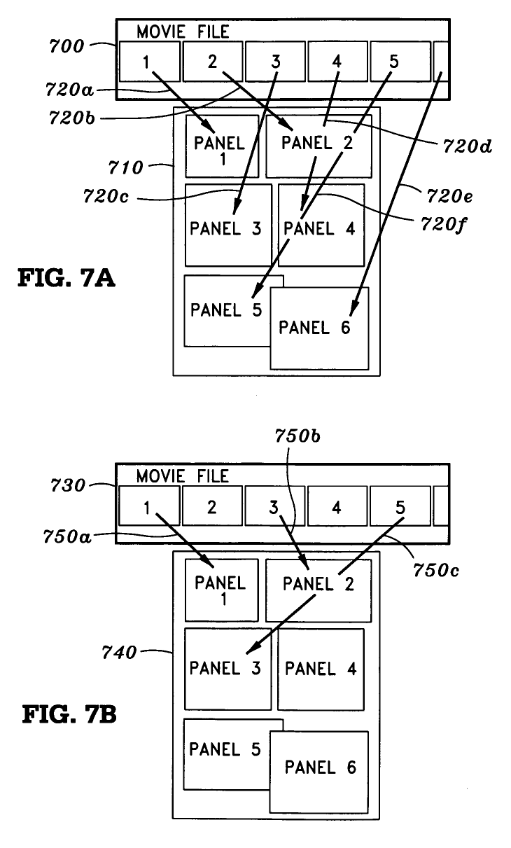

Referring now to FIGS. 7A-7B, depicted are embodiments of how gaming-based media content may be used to automatically populate a plurality of panels of one or more template over several panels and/or pages. FIG. 7A depicts an embodiment in which the process of filling the individual panels (i.e., panels 1-6) of a template 710 is automated by sequentially populating the panels with individual frames (i.e., frames 1-6) from a movie file 700. For example, arrow 720a shows the population operation for Frame 1 to Panel 1, while arrow 720b shows the population operation for Frame 2 to Panel 2, and so on. Similarly, arrows 720c-720e correspond to the population operations for Frames 3-6, respectively.

Referring now to FIG. 7B, depicted is another embodiment in which a series of panels (i.e., Panels 1-6) of a template 740 are automatically populated by skipping frames of a movie file 730 by a predetermined factor (e.g., every other frame, every third frame, etc.). For example, in the embodiment of FIG. 7B only every other frame is used to populate the template 740. In particular, arrow 750a shows the population operation to be performed for Frame 1, while arrows 750b and 750c show the population operations for Frames 2 and 3, respectively.

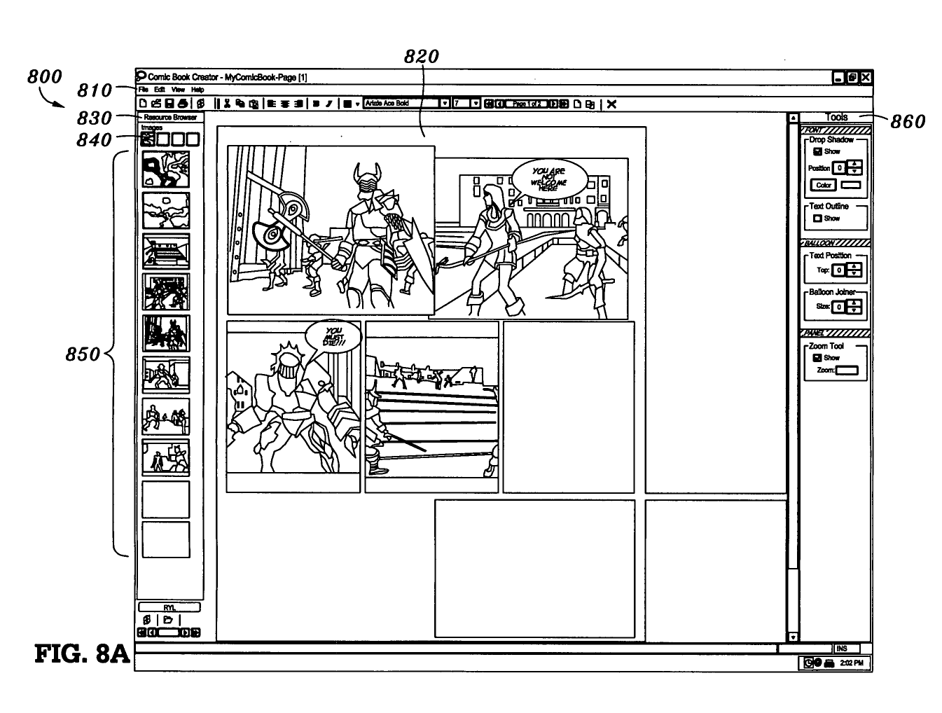

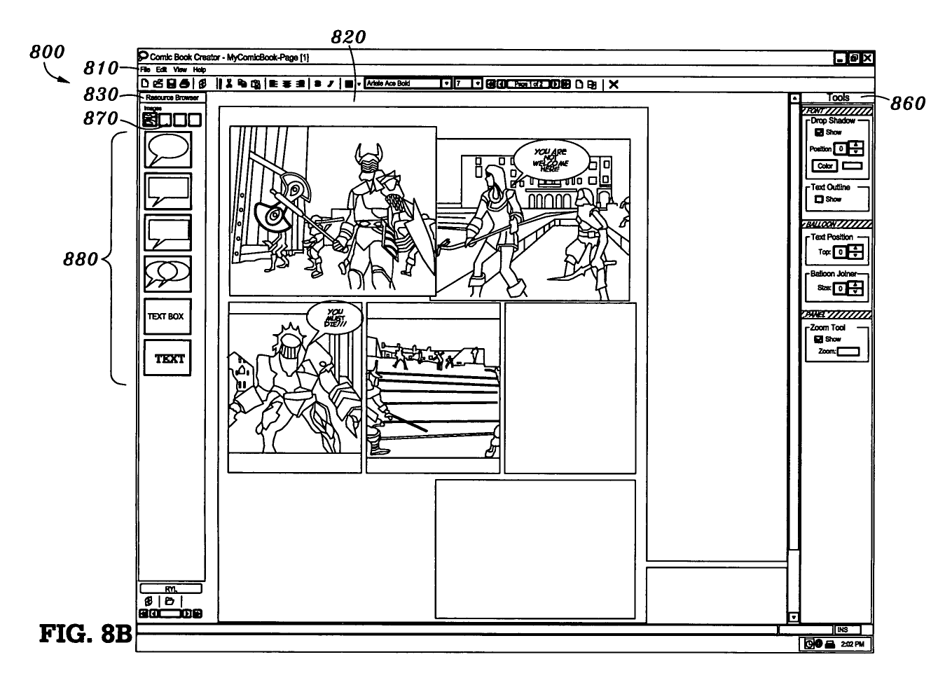

Referring now to FIG. 8A, depicted is one embodiment of a GUI 800 usable to implement one or more embodiments of the invention. GUI 800 includes a top level menu 810, as is generally known in the art. GUI 800 further includes template 820, which is comprised of 7 separate panels, 4 of which have already been populated. Moreover, text has been added to two of them, as shown in FIG. 8A.

GUI 800 also includes a resource browser portion 830 which contains the available content for populating the template 820. As previously discussed, such content may include images and/or video clips captured from video gaming activities. Such content may further include “talking balloons,” caption boxes, shapes, lines, etc. In this embodiment, the images icon 840 under the resource browser portion 830 has been selected. When the images icon 840 is selected, the resource browser portion 830 may be populated with all of the available images 850. Users may then click on a desired one of the images 850 and perform a drag and drop operation onto a desired panel. As previously mentioned, the image may then be positioned and/or scaled, as desired. Note that in this embodiment, 4 images have already been dragged and dropped from the list of available images 850 onto the template 820. GUI 800 is further shown including a tools portion 860 for performing various formatting operations and the like (e.g., change font, text color, balloon position, etc.).

Referring now to FIG. 8B, depicted is another embodiment of the GUI 800 in which the text icon 870 under the resource browser portion 830 has been selected by a user. As shown, when the text icon 870 is selected the resource browser portion 830 may be populated with all of the available text boxes/balloons 880. By clicking on a desired one of the text boxes/balloons 880, a user may insert text onto one or more of the panels which comprise the template 820. Note that in this embodiment, 2 text balloons have already been dropped onto the template 820, and populated with user text.

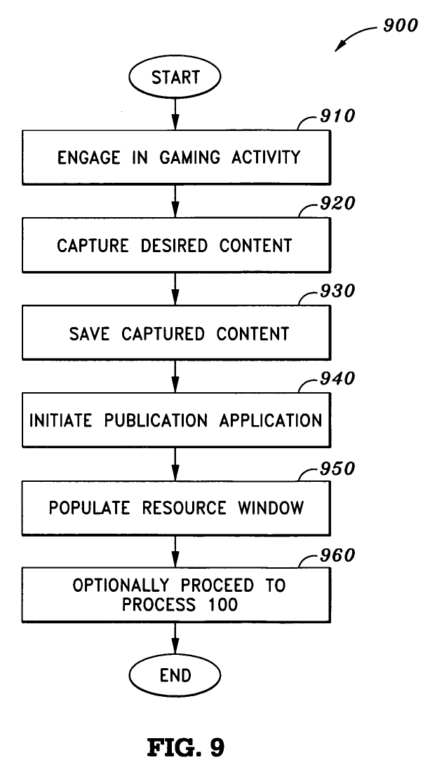

FIG. 9 is a process for capturing and utilizing gaming-based media content in accordance with one embodiment of the invention. In particular, process 900 begins with a user engaging on a gaming activity at block 910. As mentioned above, this activity may be online gaming in a RPG/MMORPG environment, or may similarly be offline single- and multi-player gaming.

At block 920, a user may capture the desired gaming content. Although beyond the scope of the present disclosure, it should be appreciated that a user may capture gaming content using native capture functionality or third-party utilities that copy the screen memory contents to one or more formatted files. At this point, the content that has been captured may be saved by the user at block 930. In one embodiment, such content is saved locally to the user's computer system, or may similarly be saved in a remote database which is accessible by the user's computer system.

Process 900 continues to block 940 where the user can open a publication software application and run/execute the application on the user's computer system. In one embodiment, this publication application provides content publication functionality for gaming-based media content. At this point, process 900 continues to block 950 where a resource window (e.g., resource browser portion 830) is automatically populated with the content that was saved previously at block 930. In one embodiment, process 900 may then be followed by the process 100 of FIG. 1 for generating a publication based on the captured media content.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A method for creating a publication comprising:
capturing media content based on a gaming activity;
populating a plurality of panels of a page template with said media content;
generating a first digital page using said page template and media content;
compiling a plurality digital pages, which includes said first digital page, into a publication.

2. The method of claim 1, wherein said gaming activities comprises online role-playing gaming.

3. The method of claim 1, wherein said media content includes at least one of video content and image content.

4. The method of claim 1, wherein said media content includes a video file, and said populating comprises selecting individual frames from said video file to populate said plurality of panels.

5. The method of claim 1, further comprising choosing said page template from a plurality of available page templates.

6. The method of claim 1, wherein said populating comprises performing a drag-and-drop operation to associate a particular portion of said media content with a particular panel of said plurality of panels.

7. The method of claim 1, further comprising inserting text-based content onto said page template.

8. The method of claim 7, wherein said text-based content provides serves as a narrative for said media content.

9. The method of claim 1, further comprising printing said publication in the form of a comic book.

10. A publication based on media content captured from actual gaming activities, the publication comprising a plurality of pages generated from one or more page templates, wherein the one or more page templates each include a plurality of panels that are populated with portions of said media content.

11. The publication of claim 10, wherein said gaming activities comprises online role-playing gaming.

12. The publication of claim 10, wherein said media content includes at least one of video content and image content.

13. The publication of claim 10, wherein said media content includes a video file, and said plurality of panels are populated with selected frames from said video file.

14. The publication of claim 10, wherein said one or more page templates are user selectable from a plurality of page templates.

15. The publication of claim 10, wherein said plurality of panels are populated by a drag-and-drop operation that associates a particular portion of said media content with a particular panel of said plurality of panels.

16. The publication of claim 10, wherein said publication further includes text-based content that serves as a narrative for said media content.

17. The publication of claim 10, wherein said publication is printed in the form of a comic book.

18. A computer program product comprising:
a computer readable medium having computer executable program code embodied therein to create a publication, the computer readable medium having:
computer executable program code to capture media content that is based on a gaming activity;
computer executable program code to populate a plurality of panels of a page template with said media content;
computer executable program code to generate a first digital page using said page template and media content; and
computer executable program code to compile a plurality digital pages, which includes said first digital page, into a publication.

19. The computer program product of claim 18, wherein said gaming activities comprises online role-playing gaming.

20. The computer program product of claim 18, wherein said media content includes at least one of video content and image content.

21. The computer program product of claim 18, wherein said media content includes a video file, and said computer executable program code to populate comprises computer executable program code to select individual frames from said video file for populating said plurality of panels.

22. The computer program product of claim 18, further comprising computer executable program code to choose said page template from a plurality of available page templates.

23. The computer program product of claim 18, wherein said computer executable program code to populate comprises computer executable program code to perform a drag-and-drop operation to associate a particular portion of said media content with a particular panel of said plurality of panels.

24. The computer program product of claim 18, further comprising computer executable program code to insert text-based content onto said page template.

25. The computer program product of claim 24, wherein said text-based content provides serves as a narrative for said media content.

26. The computer program product of claim 18, further comprising computer executable program code to print said publication in the form of a comic book.
